(19) United States
(12) Patent Application Publication
(10) Pub. No.: US 2009/0015005 A1
(43) Pub. Date: Jan. 15, 2009

(54) Rigid gasket aseptic connector

(76) Inventor: Theodore D. Johnson, Clearwater, FL (US)

Correspondence Address: SHUMAKER LOOP & KENDRICK, 101 E. KENNEDY, SUITE 2800, TAMPA, FL, 33672-0609, US

(21) Appl. No.: 12/214,875

(22) Filed: Jun. 23, 2008

Related U.S. Application Data
(60) Provisional application No. 60/945,663, filed on Jun. 22, 2007.

(51) Int. Cl. B61G 5/08; F16L 11/12

(52) U.S. Cl. 285/45; 285/70

(57) ABSTRACT

The connector of the present invention includes a flanged connector having a tabbed gasket which creates an efficient leak-proof, high-pressure connection.

This claims priority to U.S. Provisional Application No. 60/945,663, filed on Jun. 22, 2007 and titled “ASEPTIC CONNECTOR”.

### BACKGROUND

There exists a demand for inexpensive, simple, easily fabricated, disposable flange connectors having the ability to endure high pressures without the risk of deforming and thereby becoming susceptible to leakage. For many applications, the connectors must simply be able to tolerate high pressures without leaking or permitting air or other undesirable pollutants into the line. For example, many research applications are performed with chemicals which can be oxidized by air.

In another example, flange connections are often used to support a sheet of filtration material. Because of this, the pressure in the vicinity of the connectors is elevated, even more so as the filter material clogs. In such an environment, connectors must be able to form a seal which is resistant to leaking or admitting pollutants at high pressure.

For many applications, the connectors must be sterile, such as in the pharmaceutical industry, (drug preparation and testing) or research in the biological sciences. While research involving biological systems may not necessarily involve high pressures, the ability to form a sterile seal is as important as the ability to form a pressure-tight seal. This ability depends on the ability to form a seal, but also on external factors, such as the processing, storage and handling of the connector.

Connectors have traditionally required two differently designed connectors in order to form a seal: 1) a “male” connector, which often has a member which can be insertably fitted into 2) a “female” member, which has a void into which the male member can be sealingly fitted. Such connectors have a disadvantage in that their manufacture requires two different designs and are thus inherently expensive to manufacture and use, requiring the user to purchase and store separate lots of connectors.

Moreover, the use of elastomeric gaskets has heretofore been thought as one of the best ways to ensure the most effective seal. Elastomeric gaskets are used in standard connectors to enhance the sealing efficiency of a double wall contact. Essentially, elastomeric gaskets are thought to enhance the seal by deforming to completely fill the double cavity formed by pressing two connector flanges together. The gasket provides a degree of support to the inner and outer wall of the cavity, reducing the incidence of inner wall buckling, and in case buckling does occur, also prevents leakage from the inner wall from reaching the outer wall. Unfortunately, in order to function most effectively, the elastomeric gasket must deform to fill the entire cavity created upon face-to-face connection of the connector flanges. Thus, very little tolerance existed for gasket/cavity volume mismatch; while the gaskets are deformable, they generally have low compressibility. Thus, a gasket having an excess or shortfall in volume can lead to leakage.

Surprisingly, it has been found that certain connectors, while forming connections of relatively low surface area, easily form seals having a pressure tightness up to and exceeding 110 psi. Furthermore, such a low contact area enables the easy manufacture of the connectors as genderless connectors, eliminating the expense of manufacturing, purchasing and storing two different lots of connectors. Moreover, a single-piece molded rigid gasket in each connector (for a total of two gaskets per connection) can be used with such a system, and the use of such gaskets gives a highly pressure-tight seal. The pressure-tight seal obtains despite the face that the gasket is not elastomeric and cannot deform to fill the cavity, and despite the fact that the gaskets, when used in pairs in a connection, do not completely fill the volume of the cavity.

The present invention comprises a flange connector designed so that, if desired, it can be produced as a genderless connector, the connector further comprising an annular cavity in the flange, and a rigid gasket which can reside in the cavity. Further disclosed is a sterile genderless connector as above, with an insert subassembly membrane disposed across the connecting surface of the flange for maintaining sterile conditions. Further disclosed is a sterile, genderless connector which additionally comprises a retentive cap. Further disclosed is a sterile, genderless connector which additionally comprises a shrink band.

By “genderless” it is meant that the connectors which form the connection are designed in such a way that a connection is comprised of two parts which, upon forming the connection, do not interact in a “male-female” fashion, i.e., the coupling does not take place by the insertion of a “male” part into a “female” part, but is comprised of two structurally identical members. Each of the members is referred to as “genderless.”

By “flange connector,” it is meant that the connector pieces have flange-like areas which extend perpendicularly to the direction of flow.

In one embodiment, (FIG. 1) the present invention comprises a flange connector (1) comprising a flange (5) having a face (10) and a reverse (15), an end section (20) which is a tubular or other shaped and which can be connected to a hose or “line,” thus enabling the connector to be inserted inline. The flange extends perpendicular to the anticipated flow of the line, which is parallel to the axis of the end section. The end section and the flange are centered about the same axis, and they are positioned in series, with the back surface of the flange attached to the front portion of the end section. The end section can be designed for inline insertion in any manner which secures the line to the end section. Modes such as a barbed connector which holds by stretching a polymer line, a smooth connector which slides inside a line and is secured with a hose clamp, or other appropriate designs for the end portion can be used. The flange is preferably circular, disposed around the same axis as the end connector. The flange front has an annular cavity disposed into its front surface (25). The cavity is bounded by two annular sealing walls of equal height (30) and disposed concentrically with respect to each other and the flange. The cavity has a third bounding surface which is essentially the cavity bottom (35). The cavity bottom may be an annular surface which is disposed parallel to both annular sealing walls, or it may have features such that its depth varies with radius. However, it is preferred that the cavity have a cross section profile which does not have an angular variance. In one embodiment, the flange connector is one piece molded. In yet another embodiment, the flange connector is polycarbonate. If desired, the flange face can have connecting means at its edges (40) to maintain the flange face to flange face connection which occurs upon forming a connection. Alternatively or additionally, the flanges can be locked together with one or more clamps. In one embodiment, the flange faces are held together by one or more grooved arcs which accept the edge of the face-to-face flange assembly. If desired the arcs can be held in place with a band which is wrapped circumferentially around the grooved arcs. In an embodiment the grooved arcs are of polycarbonate).

In one embodiment, (FIG. 2) the present invention comprises a rigid gasket (101). The gasket comprises inner (105) and outer (110) radii, upper (115) and lower (120) surfaces, and tab projections (125) which originate at and extend from the lower surface. The rigid gasket is preferably formed from a material having a rigidity equal to, or, in an embodiment, greater than the rigidity of the flange connector. Exemplary materials include, but are not limited to steel, thermoplastics such as Teflon, polycarbonates, ABS, styrenes or thermoset materials.

In an additional embodiment, the rigid gasket is of the same material as the flange connector, and in yet other embodiments, the rigid gasket is one-piece molded polycarbonate. Referring to FIG. 1, the rigid gasket is dimensioned to reside in the connector cavity. By “reside,” it is meant that the gasket inner and outer diameters are such that the gasket can be seated in the cavity. In other words, the inner radius of the gasket is greater than the inner radius of the cavity, but the outer radius of the gasket is less than the outer radius of the cavity. Note that the gasket can reside in the cavity, yet still extend above the edge of the cavity in its unactivated state. By “unactivated,” it is meant that the gasket is not compressed into the cavity as it would be, for example, if two gasket bearing flange connectors were pressed together face-to-face such as when subjected to the conditions of a closed connection.

The tab projections which extend from the lower surface can be added to the gasket after the gasket is one-piece molded. Alternatively, the tabs can be fabricated as part of the gasket in the one piece molding process. In one embodiment, the tabs are of a different material than the flanged connectors. In another embodiment, they are of the same material as the flanged connectors. Referring to FIG. 2, the tabs are depicted as extending from the inner diameter outward. However, other configurations are possible, such as from the outer diameter inward, or a staggered configuration in which alternate tabs are directed inward. Note that the geometry of the tab shapes is preferably such that upon compression of the gasket into the cavity, the tab edges do not interfere with each other as the tabs flex into a position which is at a shallower angle to the lower surface of the gasket, at least over the necessary compression distance. By “compression distance,” it is meant the distance the gasket must be compressed into the cavity in order to form the connection. Note that this is generally the distance the gasket must be pressed into the cavity such that the top of the cavity walls are flush with the upper surface of the gasket.

While the Figures depict tabs which are essentially rectangular, other tab geometries which may be suitable for certain situations are the following: It may be preferable to have the lower edge of the tab to have a curvature, such as, for example, a curvature which matches the curvature of the cavity. This type of geometry will allow the maximum compression distance for a given tab length. It may be desirable to have a gasket which gives an increased resistance beginning at a given depth. For example, the inclusion of tab extensions which flex circumferentially when they contact the outer wall of the cavity gives an increased compression resistance at the point where the tips of the extensions come into contact with the outer wall of the cavity. It may be desirable to utilize tabs which extend inward, such as from the outer diameter. Such tabs may have a more triangular shape.

In addition it should be noted that tabs may be attached to the lower annular surface of the gasket at places other than its edges. Furthermore, the tabs may extend in directions other than inward and outward. For example, the present invention includes within its scope tabs which are attached in a radial manner and flex circumferentially. However, except for the following exception, it is generally preferred that the gasket/tab/cavity geometries be such that the gasket can be compressed into the cavity such that its surface is flush with the face of the flange or tops of the cavity walls. It is even more preferred that the gasket/tab/cavity geometries be such that the gasket can be compressed even further.

(Exception: The above is subject to the condition that the gasket be pressed flush with the tops of the cavity. It should be noted that in the formation of a connection, two gaskets and two cavities are in use. Encompassed within the scope of the present invention is the asymmetrical situation in which the cavity depths, gasket heights, and tab geometries of both connectors are such that upon formation of the connection, one of the gaskets protrudes above the rim of its associated cavity, but the other gasket absorbs the slack, and the connection is still pressure tight.)

In general, in situations where neither the inner wall of the cavity nor the inner wall of the gasket are tapered, the gasket preferably has inner and outer diameters such that it can reside in the cavity, and more preferably has an inner diameter which is larger than the inner diameter of the cavity by less than about 50 thousandths of an inch, more preferably, less than about 20 thousandths of an inch, and even more preferably, in the range of from about 1 to about 5 thousandths of an inch.

Furthermore, in one embodiment there exists a slight taper on the inner diameter of the rigid gasket (and/or an opposing taper on the inner diameter of the cavity) such that as the rigid gasket is compressed down into the cavity, the average tolerance between the inner wall of the gasket and the inner wall of the cavity is reduced, and in one embodiment, becomes a line to line fit. Once this condition occurs the inner gasket wall is actually re-enforced by hoop strength of the rigid gasket; hence, any movement of the inner gasket wall outward (buckling) as a result of internal pressure will be reduced or eliminated by the re-enforcing affect of the rigid gasket. This re-enforcing affect by the gasket rigid is accomplished by the unique design/material choice/dimensional relationship between the gasket, the cavity and the depth of compression applied, such as by an the external clamp.

Furthermore, it is preferable that the combined dimensions of the thickness of the tabs and the gasket body height is less than the cavity depth. By “thickness of the tabs” is meant the short dimension of the tabs. By “gasket body height” is meant the thickness of the gasket in the direction along its highest symmetry axis, i.e., the axis extending through the hole in the middle. As a practical result, the gasket can be compressed such that its upper surface is flush with the inner and outer walls of the flange connector.

Moreover, it is preferred that the combined dimensions of the rise and the gasket body height are greater than the cavity depth. By “rise” is meant the distance the uncompressed tabs raise the gasket off the floor of the cavity. By “cavity depth” is meant the distance between the cavity floor and the top of the cavity walls. As a practical result, the uncompressed gasket extends above the inner and outer walls of the cavity.

An additional embodiment of the present invention is a rigid gasket which does not comprise tabs, but is placed upon a “wave washer. As with the tab-bearing embodiment, the dimensions of the washer and the gasket are generally such that the uncompressed gasket extends above the walls of the cavity, and the gasket, when compressed, can sink to such a level that it does not protrude above the tops of the cavity walls.

In one embodiment, the connector of the present invention comprises an insert sub assembly, and optionally, an retentive cap. The insert sub-assembly covers the entire flange face in order to prevent contact contamination of the flange face. In one embodiment, the insert sub-assembly is anchored at edges of the flange by a mild adhesive. Note that the shape of the insert sub-assembly can be modified to accommodate any features on the flange face, such as connectors, etc.

In yet another embodiment, the connector of the present invention comprises a retentive cap which can be applied over the insert sub-assembly, thus preventing premature removal and contamination, and also providing a means for handling the connector without touching the end connector or other preferably sterile surfaces.

It is therefore intended that the foregoing detailed description be regarded as illustrative rather than limiting, and that it be understood that it is the following claims, including all equivalents, that are intended to define the spirit and scope of this invention.

### BRIEF DESCRIPTION OF THE DRAWINGS

FIG. 1 is a flange connector/rigid gasket assembly.

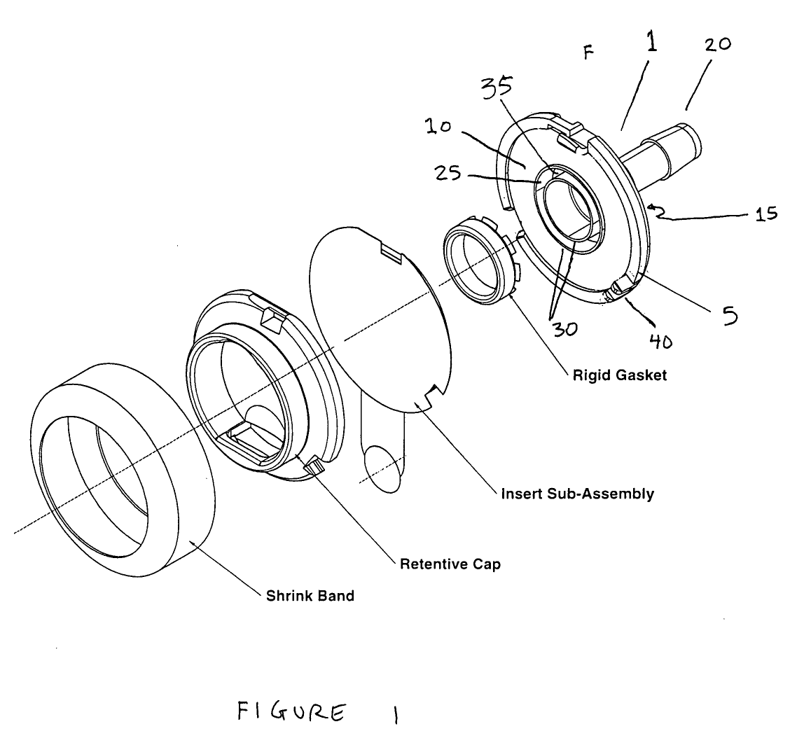

FIG. 2 is a rectangular-tabbed rigid gasket.

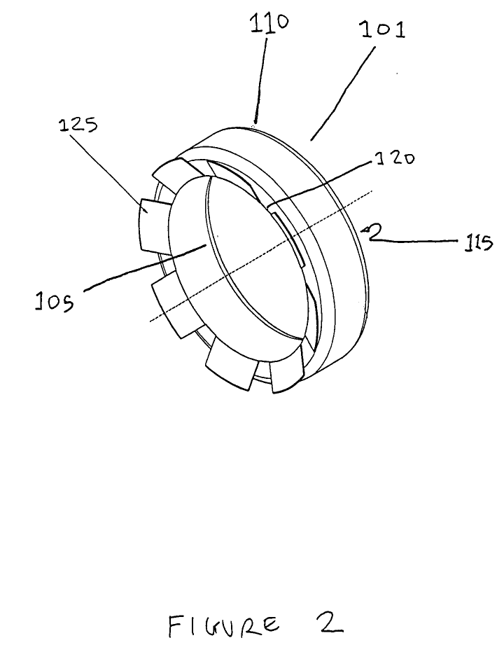

We claim:

1. A genderless connector comprising:
a flange connector comprising a tubular end connector and a flange, said flange having a back and a face, said tubular end connector connected to the back of said flange such that the flange connector and end connector are coaxial with respect to the axis of highest symmetry, said flange comprising an annular cavity symmetrically and concentrically disposed into its face, the cavity having an inner wall at an inner radius, an outer wall at an outer radius, and a floor comprising an annular surface bounded by said inner radius and said outer radius; and
a rigid, annular gasket having upper and lower annular surfaces, each having an inner and outer diameter, a gasket body height, and inner and outer concentric cylindrical side walls which are disposed at right angles to the inner and outer diameters, respectively; wherein said gasket comprises tabs extending downward from the lower annular surface, said tabs forming acute angles with said lower surface and having a thickness and a rise;
wherein the gasket has inner and outer diameters of a magnitude such that it can reside in the cavity; wherein the combined dimensions of the thickness of the tabs and the gasket body height is less than the cavity depth, and wherein the combined dimensions of the rise and the gasket body height is greater than the cavity depth.

2. A genderless connector as in claim 1 wherein the gasket is one piece molded, including the tabs.

3. A genderless connector as in claim 1 wherein the gasket is one-piece molded, except for the tabs.

4. A genderless connector as in claim 1 comprising tabs which are rectangular.

5. A genderless connector as in claim 1 comprising tabs which extend outward.

6. A genderless connector as in claim 1 wherein the tabs extend outward from the inner diameter of the lower annular surface.

7. A genderless connector as in claim 1 wherein the gasket comprises tabs that extend inward.

8. A genderless connector as in claim 1 wherein the gasket comprises tabs that extend inward from the outer diameter of the lower annular surface.

9. A genderless connector as in claim 1 wherein the gasket comprises tabs that extend circumferentially.

10. A genderless connector as in claim 1, further comprising an insert subassembly.

11. A genderless connector as in claim 1 further comprising a retentive cap.

12. A genderless connector as in claim 1 wherein the flange face or the edges thereof bear connecting means which enable the genderless connector to be attached, in a flange face to flange face manner, to another genderless connector.

13. A connector assembly comprising two genderless connectors as in claim 1, wherein the flange faces of the connectors are in contact such the gasket of the first connector is in contact with the gasket of the second connector.

14. A connector assembly as in claim 13 further comprising one or more clamps.

15. A connector assembly as in claim 14 wherein the clamps are grooved arcs which accept the flange edge of the connector assembly.

16. A connector assembly as in claim 15 further comprising a band which is wrapped circumferentially about the grooved arcs.

17. A connector assembly comprising two flange connectors and two rigid gaskets; wherein the flange faces of the connectors are in contact such the gasket of the first connector is in contact with the gasket of the second connector; and wherein;
a) the distance from the flange face to the cavity floor on one connector is not equal to that in the other connector; and/or
b) the sum of the gasket height and rise on one connector is not equal to that of the other connector.
